(19) United States
(12) Patent Application Publication
(10) Pub. No.: US 2006/0156626 A1
(43) Pub. Date: Jul. 20, 2006

(54) RAISED BED PLANTER HAVING AN INTEGRATED SEATS AND IRRIGATION SYSTEM AND KIT FOR SAME

(76) Inventor: Carol M. Seaman, Lincoln, RI (US)

Correspondence Address: BARLOW, JOSEPHS & HOLMES, LTD., 101 DYER STREET, 5TH FLOOR, PROVIDENCE, RI, 02903, US

(21) Appl. No.: 11/275,594

(22) Filed: Jan. 18, 2006

Related U.S. Application Data
(60) Provisional application No. 60/644,874, filed on Jan. 18, 2005.

(51) Int. Cl. A01G 9/02

(52) U.S. Cl. 47/79

(57) ABSTRACT

A raised bed planter includes a planter body having four bed walls with four corners that define a planting area for holding soil and cultivating plants therein. The planter body has an open top end and an open bottom end. Four seats are connected to the planter body at each of the respective four corners. Collectively, the four seats allow a gardener to reach all portions of the planting area when used in turn. A soaker hose is connected to the planter body and suspended within the planting area of the planter body. The soaker hose has a connector configured to accept the attachment of a common garden hose thereto and is in fluid connection therewith. A pest control barrier and weed control barrier line the open bottom end of the planter body.

### CROSS-REFERENCE TO REALTED APPLICATION

This application claims priority to earlier filed U.S. Provisional Application Ser. No. 60/644,874, filed Jan. 18, 2005, the contents of which are incorporated herein by reference.

### BACKGROUND OF THE INVENTION

1. Field of the Invention

This application relates generally to planters for flower gardens, and more specifically to a raised bed planter having an integrated irrigation system, pest barrier, weed control barrier and seats.

2. Background of the Related Art

Gardening is a very popular pastime enjoyed by many of all skill-levels throughout the world. However, gardening is also a difficult skill to learn and also sometimes involves hard physical labor. Moreover, many people who enjoy gardening are unable to do so because they lack suitable soil, adequate space, or due to physical limitations such as a medical condition like arthritis. Therefore, there is a perceived need in the community for a planter system to enable the both the novice and experienced garden enthusiast to set up a small garden with little maintenance and physical exertion.

### SUMMARY OF THE INVENTION

The present invention solves the problems of the prior art by providing a solution for the garden enthusiast to have a low-cost and easy-to-assemble raised bed planter, which requires little physical exertion to set up and maintain.

Briefly, the raised bed planter of the present invention includes a planter body formed of four bed walls erected in a box-shape with four corner seats mounted thereon. The bottom end of the bed wall has a pest barrier and a weed barrier attached thereto. Suspended within the planter body is a soaker hose with a hose coupling adapted for attachment to a standard garden hose.

The raised bed planter of the invention may also be sold as a do-it-yourself kit in which the gardener or purchaser assembles the components themselves.

Accordingly, among the objects of the present invention are the provision for a raised bed planter having an integrated irrigation system.

Another object of the present invention is the provision for a raised bed planter having at least one seat for the gardener to keep them off the ground and enable them to reach the interior of the planter.

Another object of the present invention is the provision for a raised bed planter having a pest barrier.

Yet, another object of the present invention is the provision for a raised bed planter having a weed barrier.

Yet, another object of the present invention is the provision for a raised bed planter that is inexpensive and easy to mass produce.

Yet, another object of the present invention is the provision for a raised bed planter constructed of a sturdy, weather resistant material.

Another object of the present invention is the provision for a raised bed planter that can be sold as a kit.

### BRIEF DESCRIPTION OF THE DRAWINGS

These and other features, aspects, and advantages of the present invention will become better understood with reference to the following description, appended claims, and accompanying drawings where:

FIG. 1 is a front perspective view of the preferred embodiment of the present invention;

FIG. 2 is a top view of the preferred embodiment of the present invention with one seat removed; and

FIG. 3 is a side cross-section view of the preferred embodiment of the present invention showing it filled with soil mulch and plants.

### DESCRIPTION OF THE PREFERRED EMBODIMENT

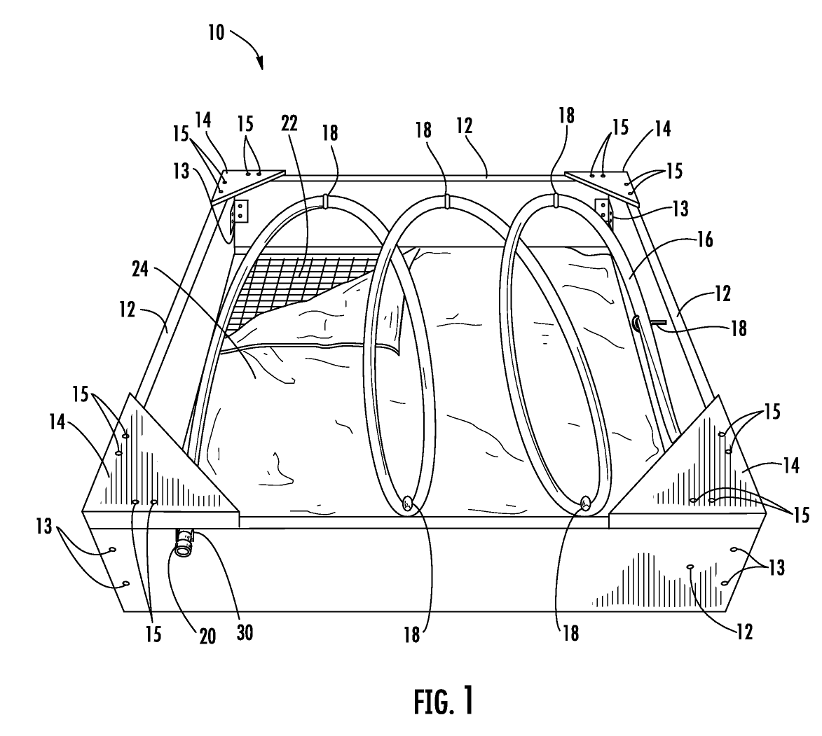

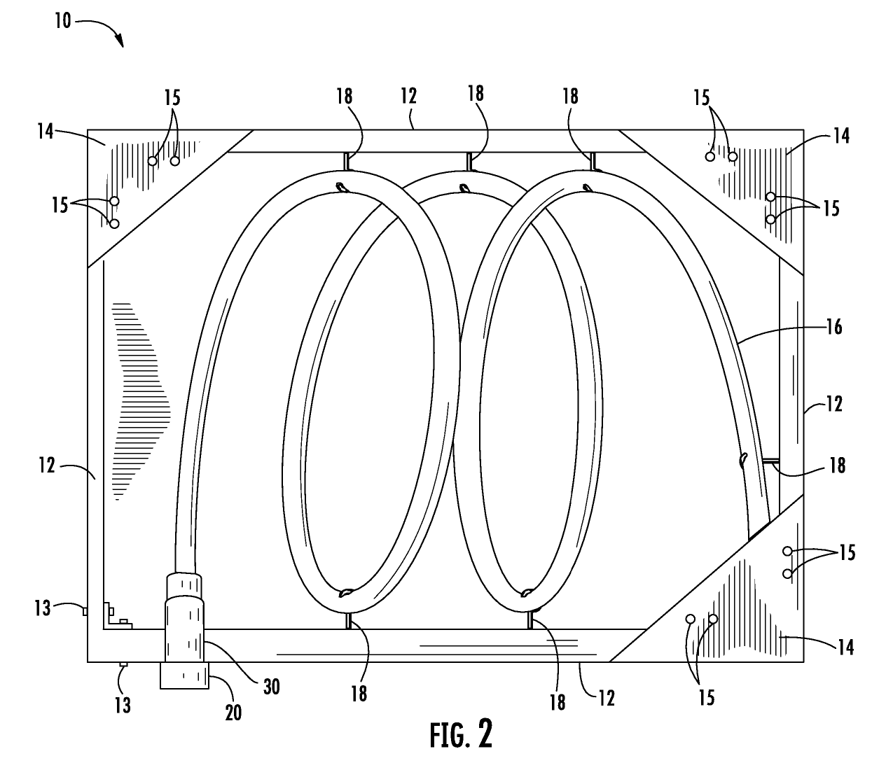

The preferred embodiment of the planter of the instant invention is shown generally at 10 in FIGS. 1 and 2. The raised bed planter has a planter body 10 having four bed walls 12 with four corners that define a planting area for holding soil and cultivating plants therein. The planter body 10 has an open top end and an open bottom end. Four seats 14 are connected to the planter body 10 at each of the respective four corners. Collectively, the four seats 14 allow a gardener to reach all portions of the planting area when used in turn. A soaker hose 16 is connected to the planter body 10 and suspended within the planting area of the planter body by a number of hose fasteners 18. The soaker hose 16 has a connector 20 configured to accept the attachment of a common garden hose thereto and is in fluid connection therewith. A pest control barrier 22 and weed control barrier 24 line the open bottom end of the planter body 10.

The four bed walls 12 of the planter body 10 are preferably made out of a durable material such as cellular PVC, but other materials could be used with equal success, such as weather-treated wood or wood products, stamped aluminum, or injection molded plastic to name a few. The bed walls 12 are attached together by a first set of fasteners 13 at each end to form a bottomless and topless box. Preferably, the first set of fasteners 13 is a pair of brackets that are held in place by a bolt, nut and washer assembly, although other arrangements are possible. The brackets, nuts, bolts, and washers are preferably made of a corrosive resistant material such as stainless steel or brass. Although the use of brackets in combination with nuts, bolts and washers is preferred, any number of other types of fasteners could be used to connect the bed walls 12 together.

Attached at each corner formed by the bed walls 12 is a seat member 14. The seat members 14 are attached to the bed walls 12 by a second set of fasteners 15. Preferably, the second set of fasteners 15 is a pair of corrosive-resistant brackets with accompanying bolts, nuts and washers. The corner seats 14 add rigidity to the bed walls 12 of the planter body 10 and also provide a seat for a gardener to sit on. The inclusion of seats 14 also has the added benefit of discouraging a gardener from stepping within the planter body 10. This can cause compaction of the soil and resulting damage to the plants 28. Although the use of brackets in combination with nuts, bolts and washers is preferred, any number of other types of fasteners could be used to attach the seat members 14 to the planter body 10.

In the bottom of the planter body 10 is a layer of pest barrier material 22. The pest barrier material 22 can be any common material commonly sold in garden supply stores for that purpose. The pest barrier material 22 may or may not be attached to the planter body 10 as desired by the gardener.

On top of the pest barrier 22 is a layer of weed barrier material 24. The weed barrier material 24 can be any common material commonly sold in garden supply stores for that purpose. The weed barrier material 24 may or may not be attached to the planter body 10 as desired by the gardener.

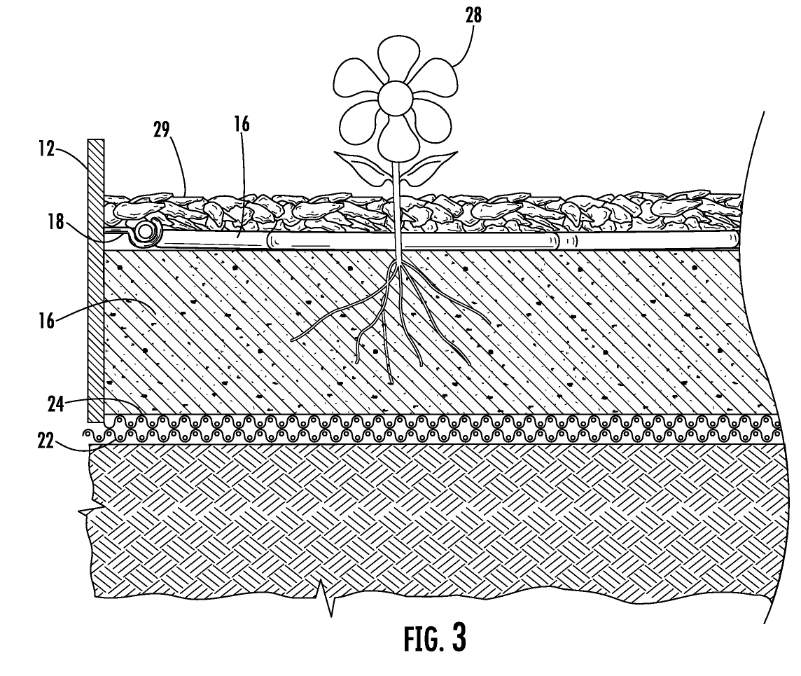

Within the planter body 10 is a third set of fasteners 18 that are attached in order to secure a soaker hose 16 within the planter body 10. As shown in FIG. 3, the third set of fasteners 18 are positioned at an optimal level within the planter body 10 such that when the soaker hose 16 is attached and the planter body 10 is filled with soil 26, the soil 26 will be of an adequate depth for the roots of the plants 28. Preferably, the third set of fasteners 18 are screw hooks configured to accommodate the soaker hose 16. A layer of mulch 29 can be added to obscure the soaker hose 16 from view and help maintain the moisture content of the soil 26.

Referring back to FIGS. 1 and 2, also within the planter body 10 is a hose notch 30 for receiving the connector end of a soaker hose. Preferably, the hose notch 30 is a U-shaped surface configured to receive the soaker hose 16. The soaker hose 16 may be any common-type soaker hose found within garden supply stores that has a connector 20 adapted to be connected to a common garden hose. The connector end 20 of the soaker hose 16 is placed within the hose notch 30 of the planter body 10 and is held in place by fastening a seat member 14 onto the planter body 10 and over the hose notch 30. The soaker hose 16 is then secured to the planter body 10 with the third set of fasteners 18.

The gardener may then place the planter 10 in a desired location where he or she would like to grow his or her plants 28. As shown in FIG. 3, the gardener then fills the planter body 10 with soil 26 up to the level of the third set of fasteners 18. The gardener may then plant his or her plants 28 within the planter 10 and add enough mulch 29 to keep the soil 26 within the planter body moist, which is desirable for growing plants, and to cover the soaker hose 16 from view.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A raised bed planter, comprising:
a planter body defining a planting area for holding soil and cultivating plants therein;
the planter body having an open bottom end and an open top end;
at least one seat connected to the planter body, the at least one seat enabling a gardener to reach any portion of the planting area while seated therein; and
means for irrigation of the planting area.

2. The raised bed planter of claim 1, further comprising a pest control barrier disposed within the planter body and beneath the planting area.

3. The raised bed planter of claim 1, further comprising a weed control barrier disposed within the planter body and beneath the planting area.

4. The raised bed planter of claim 1, wherein the means for irrigation, comprises:
a soaker hose connected to the planter body and suspended within the planting area of the container, the soaker hose having a connector configured to accept the attachment of a common garden hose thereto and being in fluid connection therewith.

5. The rasied bed planter of claim 4, wherein the soaker hose is suspended approximately three quarters of the height of the planter body.

6. The raised bed planter of claim 4, further comprising:
a U-shaped surface on the planter body defining a notch,
the notch configured to receive and retain the connector of the soaker hose therein.

7. The raised bed planter of claim 1, wherein the planter body is box-shaped with four corners.

8. The raised bed planter of claim 7, wherein there are four seats, each seat being connected to the planter body at each of the respective four corners.

9. The raised bed planter of claim 7, wherein the planter body comprises four bed walls connected end-to-end to form the box-shape.

10. A raised bed planter, comprising:
a planter body having four bed walls with four corners that defines a planting area for holding soil and cultivating plants therein;
the planter body having an open top end and an open bottom end;
at least one seat connected to the planter body at one of the respective four corners, the at least one seat allowing a gardener to reach all portions of the planting area when used in turn;
a soaker hose connected to the planter body and suspended within the planting area of the planter body, the soaker hose having a connector configured to accept the attachment of a common garden hose thereto and being in fluid connection therewith;
a pest control barrier placed within the planter body and beneath the planting area; and
a weed control barrier placed over the pest control barrier.

11. The raised bed planter of claim 10, wherein the soaker hose is suspended approximately three quarters of the height of the four bed walls.

12. The raised bed planter of claim 10, further comprising:
a U-shaped surface on one of the four bed walls defining a notch,
the notch configured to receive and retain the connector of the soaker hose therein.

13. The rasied bed platner of claim 10, wherein the at least one seats are four seats, each of the four seats connected one of the four corners of the planter body.

14. A kit for a raised bed planter comprising:
four bed walls;
at least one seat;
a first plurality of fasteners for connecting the bed walls together to form a box-shaped planter body having an open top end and an open bottom end and connecting the at least one seat at one of the respective corners of the planter body;
a soaker hose having a connector for attaching a garden hose thereto;
a second plurality of fasteners to suspend said soaker hose within said planter body;
a weed control barrier; and
a pest control barrier;
whereby the weed control carrier and pest control barrier prevent the incursion of weeds and pests, respectively, into the interior of the planter body through the open bottom end.

15. The kit of claim 14, wherein the at least one seat is triangular in shape.

16. The kit of claim 14, wherein one of the four bed walls has a U-shaped surface forming a notch thereon for accepting and retaining the connector of the soaker hose.

17. The kit of claim 14, wherein the second plurality of fasteners is configured to suspend the soaker hose at approximately three quarters the height of the four bed walls.

18. The kit of claim 14, wherein the at least one seat is four seats, each of the four seats being connected to one of the four corners of the planter body.
